(19) United States
(12) Patent Application Publication
(10) Pub. No.: US 2025/0382712 A1
(43) Pub. Date: Dec. 18, 2025

(54) SYSTEM AND METHOD FOR GENERATING HYDROGEN USING GEOTHERMAL ENERGY

(71) Applicant: Syntholene Energy Corp., Harvard, IL (US)

(72) Inventors: John Kutsch, Harvard, IL (US); Jack H. Williams, Girton (GB)

(21) Appl. No.: 19/236,563

(22) Filed: Jun. 12, 2025

Related U.S. Application Data
(60) Provisional application No. 63/659,691, filed on Jun. 13, 2024.

(51) Int. Cl. C25B 9/65; C25B 1/042; C25B 1/50; C25B 9/19; F01K 15/00; F03G 4/00; H02N 11/00

(52) U.S. Cl. CPC C25B 9/65; C25B 1/042; C25B 1/50; C25B 9/19; F01K 15/00; F03G 4/033; H02N 11/002

(57) ABSTRACT

A system and method for generating hydrogen using thermal energy in a geothermal fluid are disclosed. An electrical power generation subsystem is configured to receive geothermal fluid from a geothermal fluid source and use thermal energy in the geothermal fluid to generate electrical power. A steam generation subsystem is configured to receive water and produce steam using thermal energy in the geothermal fluid and the electrical power generated by the electrical power generation subsystem. A hydrogen generation subsystem is configured to disassociate hydrogen from the steam using the electrical power generated by the electrical power generation subsystem.

### CROSS-REFERENCE TO RELATED PATENTS

The present application claims the benefit of priority to Kutsch, U.S. Provisional Patent Application Ser. No. 63/659,691, filed Jun. 13, 2024, and entitled “Novel Process to Efficiently Directly Utilize Geothermal Energy for Industrial Heat Input for Hydrogen Generation.” The entire contents of this application are incorporated herein by reference.

### FIELD OF DISCLOSURE

The present subject matter relates to systems and methods for generating hydrogen and more particularly, systems and methods that use geothermal energy to generate hydrogen.

### BACKGROUND

Hydrogen in either gas or liquid states has various industrial and power generation applications. For example, hydrogen may be used to hydrogenate fuels, create saturated fats from unsaturated fats, produce compounds such as methanol, ammonia, hydrochloric acid, and the like, and to convert certain ores into metal. Hydrogen also holds promise as a clean fuel that may be combusted with oxygen to generate heat or combined with oxygen in a fuel cell to generate electricity directly. The byproduct of using hydrogen as a fuel source is water and thus environmentally friendly.

Although hydrogen is the most abundant substance in the universe, hydrogen on earth is usually bound in compounds such as hydrocarbons, water, and the like. Extracting hydrogen from such compounds may require significant amounts of energy to break the bonds that hold such compounds together. Further, extracting hydrogen from hydrocarbons may generate additional compounds that are not considered environmentally friendly.

Although water is abundant on earth, splitting a water molecule using conventional methods such as electrolysis, steam reforming, and the like may require a significant amount of energy such that using the resultant hydrogen as a fuel source is not economically and/or environmentally feasible.

### SUMMARY

According to one aspect, a system for generating hydrogen using thermal energy in a geothermal fluid. includes an electrical power generation subsystem configured to receive geothermal fluid from a geothermal fluid source and generate electrical power using thermal energy in the geothermal fluid. The system also includes a steam generation subsystem configured to receive water and produce steam using thermal energy in the geothermal fluid and the electrical power generated by the electrical power generation subsystem. The system also includes a hydrogen generation subsystem configured to dissociate hydrogen from the steam using the electrical power generated by the electrical power generation subsystem.

According to another aspect, a method for generating hydrogen using thermal energy in a geothermal fluid comprising operating a valve to extract geothermal fluid from a geothermal source and operating an electrical power generation subsystem to generate electrical power using thermal energy in the geothermal fluid. The method also includes generating steam using the thermal energy in the geothermal fluid and the electrical power generated by the electrical power generation subsystem. The method also includes dissociating hydrogen from the steam using the electrical power generated by the electrical power generation subsystem.

In some cases, a system for generating hydrogen using thermal energy in a geothermal fluid includes a flow control device operable to extract geothermal fluid from a geothermal fluid source, a steam generation subsystem, and a hydrogen generation subsystem. The steam generation subsystem is configured to receive a first portion of the geothermal fluid and water and to produce steam from the water using thermal energy in the first portion of the geothermal fluid. The hydrogen generation subsystem is configured to dissociate hydrogen from the steam using the electrical power generated using thermal energy in a second portion of the geothermal fluid.

In some cases, a method for generating hydrogen using thermal energy in a geothermal fluid includes operating a flow control device to extract geothermal fluid from a geothermal fluid source, generating steam using thermal energy in a first portion of the geothermal fluid and the electrical power generated using thermal energy in a second portion of the geothermal fluid, and dissociating hydrogen from the steam using the electrical power generated by the electrical power generation subsystem.

In some cases, the electrical power generation subsystem comprises a flash column and a turbine and the flash column is configured to generate steam from the geothermal fluid to drive the turbine.

In some cases, the steam generation subsystem includes a water purifier configured to generate purified water from untreated water.

In some cases, the steam generation subsystem includes a heat exchanger configured to facilitate a transfer of of the thermal energy in the geothermal fluid to a portion of the purified water.

In some cases, the steam generation subsystem heats the portion of the purified water using the electrical power generated by the electrical power generation subsystem to produce heated purified water.

In some cases, the steam generation subsystem generates steam from the portion of the purified water and supplies the steam to a solid oxide electrolyzer cell (SOEC) of the hydrogen generation subsystem.

In some cases, the SOEC uses electrical power generated by the electrical power generation subsystem to dissociate hydrogen from the steam.

In some cases, the portion of the purified water comprises a first portion of the purified water and a second portion of the purified water is used to cool the hydrogen generated by the SOEC.

In some cases, the SOEC comprises a radioactive material configured to dissociate hydrogen from the steam using radiolysis.

Other aspects and advantages will become apparent upon consideration of the following detailed description and the attached drawings wherein like numerals designate like structures throughout the specification.

### BRIEF DESCRIPTION OF THE DRAWINGS

FIG. 1 is a block diagram of a hydrogen production system in accordance with the present disclosure;

FIG. 2 is a process flow diagram of an electrical power generation subsystem of the hydrogen production system of FIG. 1;

FIG. 3 is a process flow diagram of a steam generation subsystem of the hydrogen production system of FIG. 1;

FIG. 4 is a process flow diagram of a hydrogen generation subsystem of the hydrogen production system of FIG. 1;

FIG. 5 is a process flow diagram of another embodiment of an electrical power generation subsystem of the hydrogen production system of FIG. 1; and

FIG. 6 is a process flow diagram of another embodiment of a hydrogen generation subsystem of the hydrogen production system of FIG. 1.

### DETAILED DESCRIPTION

Areas of the Earth that have significant geologic activity and underground reservoirs of water may be an abundant source of heated groundwater held under substantial pressure. As described in greater detail below, such naturally heated groundwater may be tapped and extracted and the heat and pressure of such groundwater may be used to generate electrical energy and convert purified water into steam. Such electrical energy in turn may be used to drive an electrolysis process to produce hydrogen from the steam. Because heated steam undergoes electrolysis, less electrical energy may be needed to dissociate hydrogen and oxygen from the water molecules that comprise such steam.

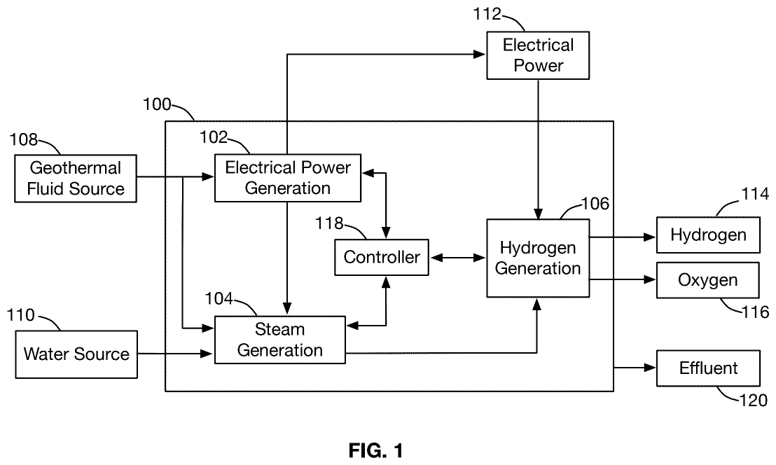

Referring to FIG. 1, a hydrogen production system 100 includes an electrical power generation subsystem 102, a steam generation subsystem 104, and a hydrogen generation subsystem 106. The hydrogen production system 100 is configured to receive geothermal fluid from a geothermal fluid source 108 such as a geothermal spring, a reservoir of geothermally heated water, a geothermal well, and the like. In some cases, the geothermally heated water is at a temperature between approximately 120 degrees Celsius and 360 degrees Celsius. A first portion of the geothermal fluid from the geothermal fluid source 108 is used by the electrical power generation subsystem 102 to generate electrical power used by the hydrogen production system 100, as described below. In some embodiments, a first portion of electrical power generated by the electrical power generation subsystem 102 may be supplied to an electrical power source 112 for, e.g., storage in a battery, an uninterrupted power supply, or supplied to the electrical grid for subsequent use by the hydrogen generation subsystem 106.

A second portion of the geothermal fluid from the geothermal fluid source 108 is used by the steam generation subsystem 104 to produce purified steam. In some embodiments, the second portion of the geothermal fluid may be passed through a distillation system if the second portion of the geothermal fluid is sufficiently free of impurities to be distilled into purified heated water. Alternately, water from a water source 110 may be heated by the second portion of the geothermal fluid to produce the purified heated water. The purified heated water is then flash evaporated to generate steam that is provided to the hydrogen generation subsystem 106. In some embodiments, the steam provided to the hydrogen generation subsystem 106 is at least 150 degrees Celsius. If the temperature of the second portion of the geothermal fluid is not sufficient to produce steam that is at least 150 degrees Celsius, the purified heated water may be heated further so that the steam generation subsystem 104 produces steam at the desired temperature. In some embodiments, a second portion of the electrical power generated by the electrical power generation subsystem 102 may be used to operate one or more devices such as an electric heater to heat the purified heated water further so that steam is produced at the desired temperature. In other embodiments, the second portion of the electrical power may be used to drive a heating device such as steam compressor that compresses the steam and/or a heater to heat the steam after generation thereof. In still other embodiments, a heater may be used to heat the purified water and the heating device may heat steam generated from the purified water to heat the steam to the desired temperature.

The hydrogen generation subsystem 106 uses electrical power from the electrical power source 112 to disassociate the steam produced by the steam generation subsystem 104 into hydrogen that is supplied into a hydrogen storage tank 114 and into oxygen that is supplied to an oxygen storage tank 116. In some embodiments, the oxygen may simply be vented into the ambient environment from the hydrogen generation subsystem 106 instead of being stored in the oxygen storage tank 116.

In some embodiments, electrical power produced by the electrical power generation subsystem 102 that is in excess of that necessary to raise the temperature of the purified heated water to produce steam by the steam generation subsystem 104 may be supplied to the electrical power source 112, which in turn is used to supply electrical power to components of the hydrogen production system 100. In other embodiments, such excess electrical power may be supplied to the hydrogen generation subsystem 106 directly and if such excess electrical power is not sufficient for electrolysis of the steam into hydrogen and oxygen, additional electrical power necessary to drive such electrolysis may be supplemented with electrical power from the electrical power source 112.

The hydrogen production system 100 also includes a controller 118 that monitors and controls operation of the electrical power generation subsystem 102, the steam generation subsystem 104, and the hydrogen generation subsystem 106 to facilitate production of hydrogen gas using geothermally heated fluid from the geothermal fluid source 108.

As described in greater detail below, the steam generation subsystem 104 and the hydrogen generation subsystem 106 may produce effluent (e.g., wastewater or condensate) that may be directed to an effluent discharge 120 such as a storage tank, the ambient environment after filtration, and the like.

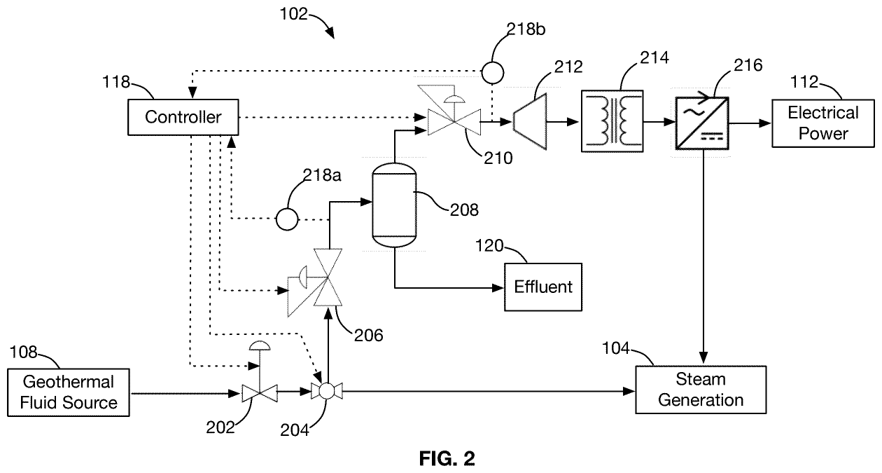

FIG. 2 shows a process flow diagram of the steam generation subsystem 104. Referring to FIG. 2, the geothermal fluid source 108 is typically under high pressure (between 20 and 25 bar) and may be tapped (e.g., by drilling a well, coupling the source to a pipe, and the like) and extracted. The pressure of the geothermal fluid underground causes the geothermal fluid to flow from the from the source 108 through a flow control device such as a pneumatic actuator valve 202, a first ball valve 204, a first downstream pressure control valve 206, and into a first flash column (or flash vessel) 208. The first flash column 208 flashes the geothermally heated fluid into steam and the steam flows through a first upstream pressure control valve 210 and drives a turbine and generator combination (hereinafter “turbine”) 212 to produce electrical power.

The controller 118 operates the pneumatic actuator valve 202 to permit flow of geothermal fluid into the hydrogen production system 100. In some embodiments, the pneumatic actuator valve 202 is normally in closed state and the controller 118 causes the pneumatic actuator valve 202 to be held in an open state when the hydrogen production system 100 is operated. Thus, in case of a power interruption or other system issue, the pneumatic actuator valve 202 will return to the closed state and the flow of geothermal fluid therethrough will cease.

In addition, the controller 118 operates the first ball valve 204 to separate the flow of the geothermal fluid into a first portion used by the electrical power generation subsystem 102 to generate electrical power and a second portion used by the steam generation subsystem 104 to generate steam. In some embodiments, the geothermal fluid in underground geothermal sources 108 may be between approximately 130° and approximately 200° Celsius at 20-28 bar. Thus, the geothermal fluid in the geothermal source 108 is subcooled (i.e., may be below the saturation temperature thereof and in a liquid state). In some embodiments, the geothermal fluid enters the flash column 208 at a temperature approximately 10° Celsius less than the temperature of such fluid when underground and in the liquid state. The controller operates the first downstream pressure control valve 206 to control the pressure of the geothermal fluid into the first flash column 208 in the liquid, subcooled state and to prevent inadvertent or premature flashing of the geothermally heated fluid before such fluid is introduced in the first flash column 208. Further, the controller operates the first upstream pressure control valve 210 to control the pressure of the geothermal fluid in the first flash column 208 for proper operation thereof. As should be apparent to one who has ordinary skill in the art, the geothermally heated fluid is introduced into the first flash column 208 and undergoes a reduction in pressure within the first flash column 208 and thereby converts to steam. In some embodiments, the steam leaves the flash column 208 at approximately 150° Celsius and at between approximately 1.5 and 2.0 bar pressure. The steam is passed through the first upstream pressure control valve 210. Any geothermally heated fluid that remains in the first flash column 208 in a liquid state (i.e., condensate) flows to the effluent discharge 120.

The flashed steam supplied through the first upstream pressure control valve 210 drives the turbine 212 to generate electrical power. In some embodiments, such steam that passes through the turbine 212 may be vented to the ambient environment. In some embodiments, the electrical power generation subsystem 102 includes a transformer 214 that converts the alternating current produced by the turbine 212 into an appropriate voltage provided to a first rectifier 216, which in turn converts the alternating current into direct current that may be used by the steam generation subsystem 104 and/or to supplement the electrical power source 112.

The controller 118 monitors signals developed by one or more pressure, flow, and/or temperature sensors 218 of the electrical power generation subsystem 102 and in response controls operation of the valves 202, 204, 206, 210, and the first flash column 208 as necessary for proper operation of the electrical power generation subsystem 102.

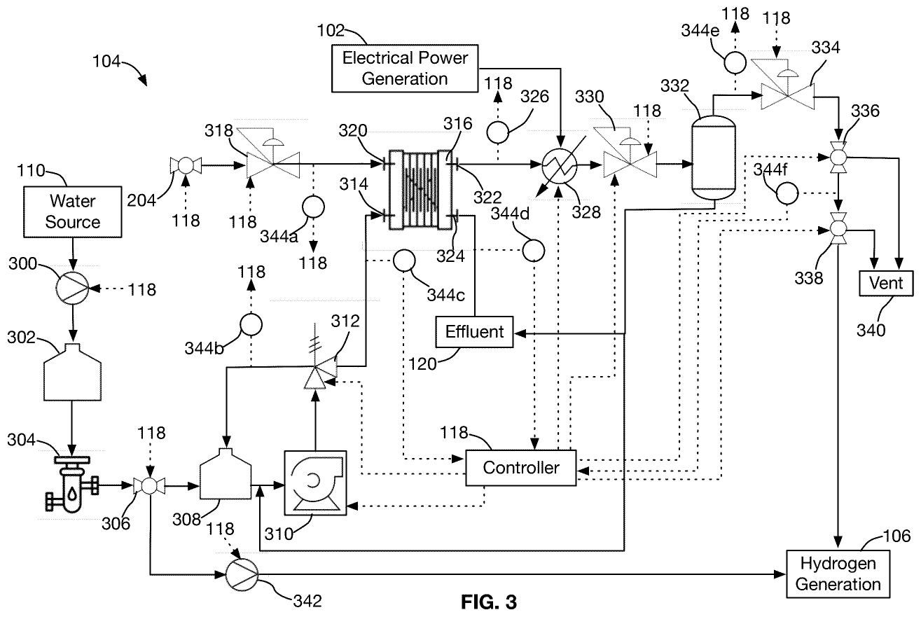

FIG. 3 is a process flow diagram of the steam generation subsystem 104. Referring to FIG. 3, a water pump 300 draws water from the water source 110 into an untreated water storage tank 302. In some embodiments, the water source 110 may be, for example, a source of untreated water such as a stream, a lake, a reservoir, groundwater, and the like. In some embodiments, the pump 300 is a low pressure pump operated by the controller 118 to maintain at least a predetermined level of water in the untreated water storage tank 302. Untreated water in the untreated water storage tank 302 is processed by a water purification system 304 to produce purified water. In some embodiments, the water purification system 304 may remove ions (e.g., fluoride, calcium, and the like), elements such as sulfur and silicas, entrained particles, undesired groundwater minerals, excess acidity or alkalinity, and the like.

The controller 118 operates a second ball valve 306 to cause a first portion of the purified water to flow from the water purification system 304 into a purified water storage tank 308 and a second portion of the purified water to flow into the hydrogen generation subsystem 106. A high pressure liquid pump 310 draws purified water from the purified water storage tank 308 through a pressure relief valve 312 and into a first input port 314 of a first heat exchanger 316.

The second portion of the geothermally heated fluid from the first ball valve 204 (FIG. 2) passes through a second downstream pressure control valve 318 and into a second input port 320 of the first heat exchanger 316. Thermal energy in the geothermally heated fluid is transferred to the purified water to heat the purified water as the fluid and water pass through the first heat exchanger 316. The purified water heated in this manner passes through a first output port 322. The (now cooled) geothermally heated fluid passes through a second output port 324 of the first heat exchanger 316 and into the effluent discharge 120.

The heated purified water flows from the first output port 322 passes through an electric heater 328, a second upstream pressure control valve 330, and into a second flash column 332. The second flash column 332 flashes the heated purified water into steam that passes through a third upstream pressure control valve 334. Any condensate that remains in the second flash column 332 after flashing of the heated purified water passes into the effluent discharge 120.

In some embodiments, a portion of the condensate from the second flash column 332 may be recirculated to combine with the purified water from purified water tank 308. The condensate from the second flash column 332 may be at a higher temperature than the purified water from the purified water tank 308. Thus, the combined condensate and purified water supplied to the heat exchanger 316 in such embodiments may be at a higher temperature than if only purified water were supplied thereto. The controller 118 may control one or more valves (not shown) between the flash vessel 332 and the high pressure pump 310 to control the portion of the condensate supplied to the high pressure pump 310 instead of being discharged into the effluent discharge 120.

The controller 118 may operate the second downstream pressure control valve 318 to supply the geothermally heated fluid into the first heat exchanger 316 at a substantially constant pressure to avoid unwanted pressure pulses and at sufficient pressure to prevent flashing of the geothermally heated fluid while such fluid is passed through the first heat exchanger 316. Similarly, the second upstream pressure control valve 330 prevents flashing of the purified heated fluid before such fluid is introduced into the second flash column 332. The third upstream pressure control valve 334 controls the pressure within second flash column 332 to control the flashing of the purified heated fluid into steam therein. In some embodiments, such pressure is approximately 1.5 bar but may be varied in accordance with the temperature of the geothermal fluid extracted from the geothermal fluid source 108.

Steam from the third upstream pressure control valve 334 passes through a third ball valve 336 that controls a total flow rate of steam provided to the hydrogen generation subsystem 106 and a fourth ball valve 338 that adjusts the flow rate of the steam provided to the hydrogen generation subsystem 106. In particular, the controller 118 operates the fourth ball valve 338 to slowly increase the rate at which steam is supplied to the hydrogen generation subsystem 106 over a period of time to prevent damage to the components thereof that may occur as a result of sudden pressure changes. The third and fourth ball valves 336, 338 are configured so that any excess steam not supplied to the hydrogen generation subsystem 106 is exhausted through one or more vents 340.

The controller 118 may operate the electric heater 328 to further heat the heated purified water from the first heat exchanger 316 to raise a temperature of the heated purified water to at least a predetermined temperature if the thermal transfer from the geologically heated fluid to the purified water in the first heat exchanger 316 was not sufficient to heat the purified water to at least such predetermined temperature. In some embodiments, the electric heater 328 may be operated using electrical power generated by the electrical power generation subsystem 102 either directly or by power supplied by the electrical power generation subsystem 102 to the electrical power source 112. In some embodiments, such predetermined temperature may be approximately 10° Celsius less than the temperature of geothermal fluid extracted from the geothermal fluid source 108 and below the saturation temperature of the heated purified water in accordance with the pressure of such water.

The high pressure liquid pump 310 is configured to provide the purified water into the first heat exchanger 316 at sufficient pressure to prevent inadvertent premature flashing of the purified water before such fluid is introduced into the second flash column 332. The controller 118 may operate the pressure relief valve 312 coupled to the high pressure liquid pump 310 to prevent excess pressure of the purified water supplied by the high pressure liquid pump 310 to the first heat exchanger 316. The pressure relief valve 312 may be operated to recirculate excess purified water to the purified water storage tank 308 as necessary to maintain the pressure of the fluid at the first input port 314 of the first heat exchanger 316 within a predetermined range that is at least the saturation pressure at the temperature of the purified water exiting the first output port 322.

In some embodiments, the steam generation subsystem 104 includes a low pressure pump 342 that is operated by the controller 118 to supply the second portion of the purified water from the second ball valve 306 into the hydrogen generation subsystem 106.

The controller 118 monitors signals generated by one or more temperature, pressure, and flow sensors 344 and operates the valves 306, 312, 318, 330, 334, 336, and 338, the pumps 300, 310, and 342, and the electric heater 328 in response to such signals to facilitate proper operation of the steam generation subsystem 104.

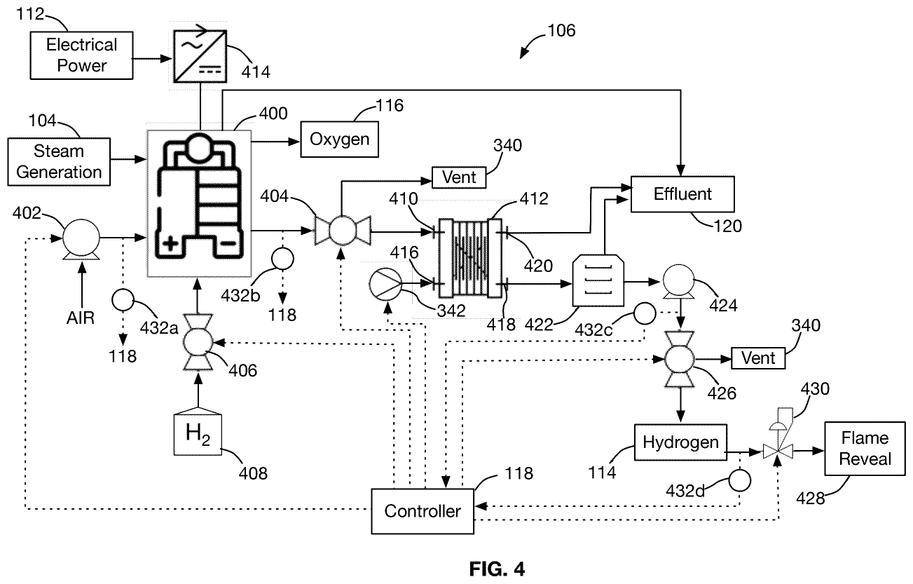

FIG. 4 is a process flow diagram of the hydrogen generation subsystem 106. Referring to FIG. 4, the hydrogen generation subsystem 106 includes a solid oxide electrolysis cell (SOEC) 400 that uses electrical power from the electrical power source 112 to dissociate hydrogen and oxygen atoms of water molecules of the steam supplied by the steam generation subsystem 104 using electrolysis. As discussed above, at least a portion of the electrical power supplied by the electrical power source 112 may be generated by the electrical power generation subsystem 102.

To prepare the SOEC 400 for electrolysis, the controller 118 operates a compressor 402 that draws ambient air, compresses the drawn air, and supplies the compressed air to an input port of the SOEC 400. In addition, the controller 118 operates a fifth ball valve 404 coupled to a hydrogen output port of the SOEC 400 so that fluid supplied to the sixth ball valve 406 is directed to the vent 340 and exhausted to the ambient environment. The compressed air is supplied to an anode side of the SOEC 400 at a pressure between approximately 4 bar and 8 bar and below 50° Cel and flow rate to remove any oxide ion buildup and other impurities from the SOEC 400. The controller 118 continues operation of the compressor 402 to continuously remove oxide ion buildup/impurities that may form during the operation of the SEOC 400. In some embodiments, the air exits the SEOC 400 and flows into the oxygen tank 116 or is vented.

Thereafter, the controller 118 operates a sixth ball valve 406 also coupled to the input port of the SOEC 400 to cause compressed hydrogen from a hydrogen source 408 to flow through the sixth ball valve 406 and into the input port of the SOEC 400. The compressed hydrogen is supplied at the pressure and flow rate to prime the SOEC 400 for operation. The compressed hydrogen passes through the SOEC 400, through the fifth ball valve 404, and exhausted through the vent 340. The compressed hydrogen is supplied to the SOEC 400 in this manner until operation of the SEOC 400 is stable (e.g., the internal temperature of the SOEC 400 is stable, hydrogen output from the SEOC is stable, and/or other indicators of the operation of the SEOC 400). In some embodiments, the compressed hydrogen is at least 99.9 percent pure and is free of any condensable water. In some cases, the compressed hydrogen is supplied to the SOEC 400 at between 4 and 8 bar. In some embodiments, the controller 118 may cause compressed hydrogen to be supplied to the SOEC 400 when the SOEC 400 is idle to prevent deactivation of the catalyst within the SOEC 400 and/or when the SOEC 400 is shutdown.

After the SOEC 400 is primed, the controller 118 operates the sixth ball valve 406 to terminate the supply of the hydrogen to the SOEC 400 and operates the fifth ball valve 404 to fluidically couple the hydrogen output port of the SOEC 400 to a first input port 410 of a second heat exchanger 412. The controller 118 then operates the third ball valve 336 and the fourth ball valve 338 (see FIG. 3) of the steam generation subsystem 104 to supply heated steam to the input port of the SOEC 400. In some embodiments, the steam generation subsystem 104 supplies steam to the SOEC 400 that is heated to at least 150 degrees Celsius.

In addition, the controller 118 operates a second rectifier 414 to provide electrical power from the electrical power source 112 to an electrical power input of the SOEC 400. The second rectifier 414 converts alternating current from the electrical power source to direct current (if necessary) and supplies the direct current at a predetermined voltage necessary for operation of the SOEC 400.

As would be understood by one having ordinary skill in the art, the SOEC 400 includes anode and cathode plates connected to the electrical power source 112 and separated by a ceramic electrolyte. Water molecules in the steam supplied to the SOEC 400 undergo electrolysis at the cathode plate by the electrical energy supplied from the electrical power source 112 and dissociate into hydrogen atoms and negatively charged oxygen ions. The hydrogen atoms combine to form hydrogen gas molecules that flow through the hydrogen output port of the SOEC 400. The negatively charged oxygen ions pass through the ceramic electrolyte and react at the anode to form oxygen gas molecules which flow through an oxygen output port of the SOEC 400. Supplying heated steam to the SOEC 400 requires less electrical energy needed for electrolysis of the water molecules compared to electrolysis of steam or liquid water at a lower temperature (e.g., at room temperature). In some embodiments, the steam is supplied to the SOEC 400 at between approximately 3 bar and 8 bar of pressure.

In some embodiments, the cathode plate of the SOEC 400 may be coated with a radioactive material such as thorium or other actinides that facilitates dissociation of the hydrogen and oxygen atoms from the water molecules by radiolysis and thus supplements the electrolytic dissociation of such atoms. In some cases, thorium may be incorporated into the cathode plate to improve conductivity of the cathode plate, which may further facilitate electrolysis within the SEOC 400.

Condensate of water molecules that are not dissociated into hydrogen and oxygen by electrolysis and/or radiolysis in the SOEC 400 flow through a waste port of the SOEC 400 to the effluent discharge 120.

Oxygen molecules flow from the oxygen outport port of the SOEC 400 to the oxygen storage tank 116 (or the oxygen may be discharged to the ambient environment). Hydrogen molecules formed in the SOEC 400 flow through the hydrogen output port of the SOEC 400, through the fifth ball valve 404, and into the first input port 410 of the second heat exchanger 412, as described above. The controller 118 operates the low pressure pump 342 to supply purified water to a second input port 416 of the second heat exchanger. In some embodiments, the controller 118 may cause unpurified water (e.g., from a river, groundwater, or another water source) to be supplied to the second input port 416 instead of the purified water. The purified water absorbs thermal energy from the hydrogen gas and cools the hydrogen gas as the hydrogen gas flows from the first input port 410 to a first output port 418 of the second heat exchanger 412 and the purified water flows from the second input port 416 to a second output port 420 of the second heat exchanger 412. The purified water exits the second output port 420 and flows to the effluent discharge 120.

The hydrogen gas that exits the first output port 418 of second heat exchanger 412 flows into a dryer 422 that removes water droplets and/or moisture entrained in the hydrogen gas. Such water flows to the effluent discharge 120. The hydrogen gas flows from the dryer 422, through a compressor 424, through a seventh ball valve 426 and into the compressed hydrogen storage tank 114. The compressor 424 pressurizes the hydrogen gas sufficiently for feeding into the hydrogen storage tank 114. The controller 118 operates the seventh ball valve 426 intermediate the compressor 424 and the hydrogen storage tank 114 to control the flow rate of hydrogen gas into the hydrogen storage tank 114. For example, the controller 118 may operate the seventh ball valve 426 to reduce the flow rate as the hydrogen storage tank 114 is filled to near capacity. In addition, the controller 118 may cause the seventh ball valve 426 to cease supplying hydrogen gas to the hydrogen storage tank 114 and instead discharge the hydrogen gas to the ambient environment through the vent 340 when the hydrogen storage tank 114 is filled.

In some embodiments, the hydrogen generation subsystem 106 may include a flame reveal 428 coupled to the hydrogen storage tank 114 by a two-stage regulator and backflush arrestor valve 430. The flame reveal 428 may be operated to provide a visual indicator of the presence of hydrogen gas in the hydrogen storage tank 114 and thus operation of the hydrogen generation subsystem 106. The controller 118 operates the regulator and backflush arrestor valve 430 to control the output pressure and flow from the hydrogen storage tank 114 to the flame reveal 428 and to prevent flashback of any flame to the hydrogen storage tank 114.

The controller 118 monitors signals developed by one or more pressure, flow, and/or temperature sensors 432 of the hydrogen generation subsystem 106 and in response controls operation of the valves 404, 406, 426, and 430, the pump 342, and the compressor 424 as necessary for proper operation of the hydrogen generation subsystem 106.

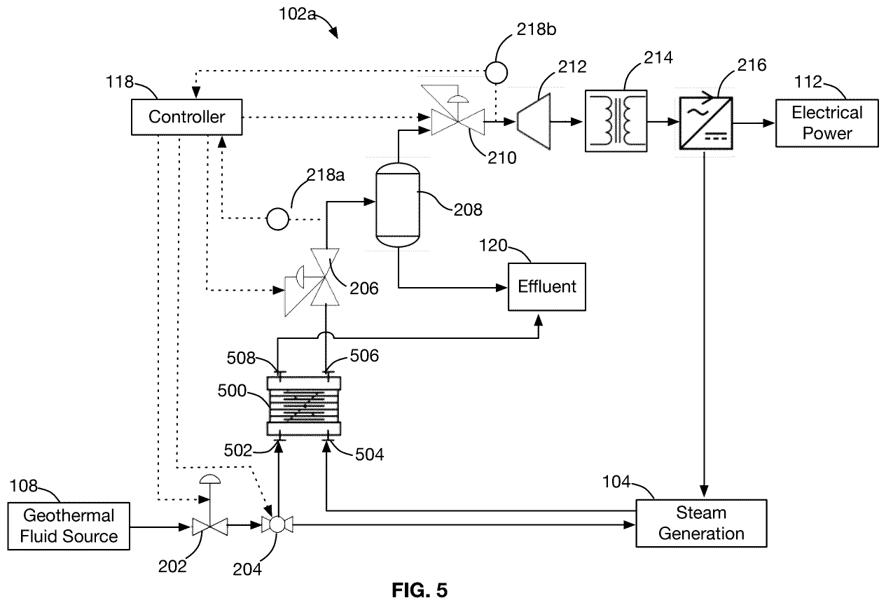

FIG. 5 is an embodiment 102a of the electrical power generation subsystem that is substantially identical to the embodiment 102 described above except the embodiment 102a includes a third heat exchanger 500 having a first input port 502 that receives geothermally heated fluid from the geothermal fluid source 108 and a second input port 504 that receives a portion of the steam generated by the steam generation subsystem 104. The steam further heats the geothermally heated fluid, and such further heated fluid exits the third heat exchanger 500 at a first output port 506 and is supplied to the flash vessel 208 (via the valve 206) to generate heated steam. The heated steam from the flash vessel 208 drives the turbine 212 as described above to produce electrical power. The steam supplied at the second input port 504 flows through the third heat exchanger 500, cools, and exits the third heat exchanger 500 at a second output port 508 and flows into the effluent discharge 120. The embodiment 102a may include one or more pumps, valves, and/or sensors apparent to one of ordinary skill in the art for proper operation of such embodiment.

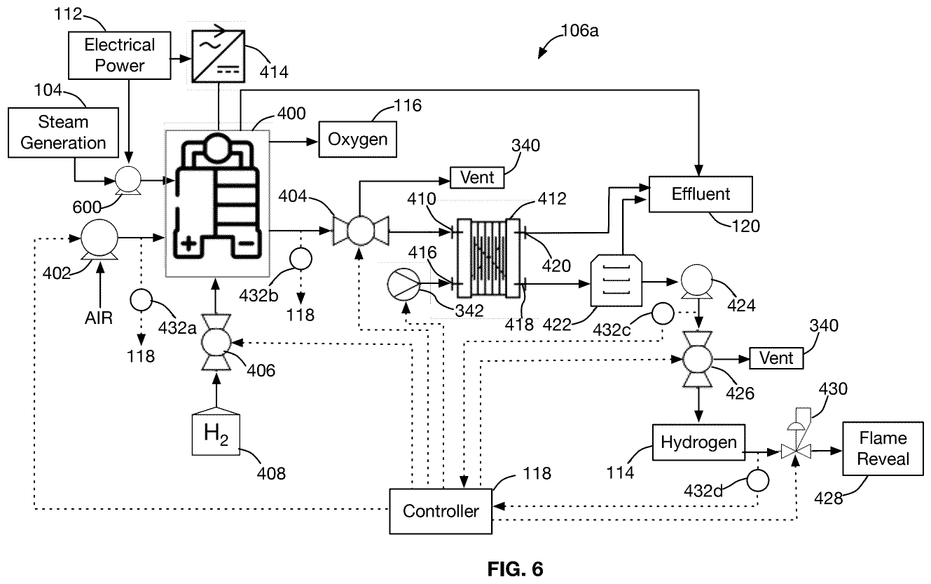

FIG. 6 is an embodiment 106a of the hydrogen generation subsystem that is substantially identical to the embodiment 106 described above except the embodiment 106a includes a heating device 600 that heats the steam produced by the steam generation subsystem 104 and supplies the heated steam to the steam input of the SOEC 400. In some embodiments, the heating device 600 may be a steam compressor that increases the pressure of the steam and thereby raises the temperature of the steam, an electric heater, or a combination of the two. Further, in some embodiments, either the heater 328 (FIG. 3) or the heating device 600 may be used. Alternately, both the heater 328 (FIG. 3) and the heating device 600 may be used in other embodiments. In some cases, heating steam using the heating device 600 may require less energy than heating the liquid purified water using the heater 328.

As should be understood by those who have ordinary skill in the art, the electrolysis device (e.g., the SOEC 400) used in the embodiments disclosed herein must be one that operates stably and includes components that can withstand temperatures of at least approximately 150° C. in order to electrolyze steam heated by energy from the geothermal source 108 to efficiently generate hydrogen. Using electrolysis to generate hydrogen from heated steam as disclosed herein may require significantly less electrical energy than that required to electrolyze water that is at room temperature. Further, because geothermal fluid once tapped may be an essentially free source of energy, the overall costs of producing hydrogen may be greatly reduced compared to alternate methods.

In some embodiments, the hydrogen production system 100 disclosed herein may be mobile and transported to the source of geothermally heated fluid by a vehicle such as, for example, a truck, a ship or barge, and the like. In some cases, some, or all of the components of the hydrogen production system 100 may remain on the vehicle while such system operates to produce hydrogen. In addition, the electrical power source 112 in such mobile applications may be provided by a combination of one or more of a central power grid, a fuel driven genset, battery power source, an uninterrupted power supply (UPS), and the like. In particular, the fuel driven genset, battery power source, and/or UPS may be employed to supplement power from the central power grid, for example, in locations proximate the geothermal fluid source 108 where power from the central power grid may not be readily available or may be unreliable.

It should be apparent to those who have skill in the art that any combination of hardware and/or software may be used to implement components of the controller 118 described herein. It will be understood and appreciated that one or more of the processes, sub-processes, and process steps described in connection with FIGS. 1-4 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules depicted in FIGS. 1-4. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within the controller 118 which includes, for example, one or more microprocessors, general purpose processors, combinations of processors, digital signal processors (DSPs), field programmable gate arrays (FPGAs), application-specific integrated circuits (ASICs), and/or graphics processing units (GPUs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

While particular embodiments of the present disclosure have been illustrated and described, it would be apparent to those skilled in the art that various other changes and modifications can be made and are intended to fall within the spirit and scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the embodiments (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

1. A system for generating hydrogen using thermal energy in a geothermal fluid, comprising:
an electrical power generation subsystem configured to receive geothermal fluid from a geothermal fluid source and generate electrical power using thermal energy in the geothermal fluid;
a steam generation subsystem configured to receive water and produce steam using thermal energy in the geothermal fluid and the electrical power generated by the electrical power generation subsystem, wherein the steam generation subsystem includes a water purifier configured to generate purified water from untreated water and a heat exchanger configured to facilitate a transfer of the thermal energy in the geothermal fluid to a portion of the purified water; and
a hydrogen generation subsystem configured to dissociate hydrogen from the steam using the electrical power generated by the electrical power generation subsystem;
wherein the steam generation subsystem heats the portion of the purified water using the electrical power generated by the electrical power generation subsystem to produce heated purified water, the steam generation subsystem generates steam from the portion of the purified water and supplies the steam to a solid oxide electrolyzer cell (SOEC) of the hydrogen generation subsystem, the SOEC uses electrical power generated by the electrical power generation subsystem to dissociate hydrogen from the steam, wherein the portion of the purified water comprises a first portion of the purified water and a second portion of the purified water is used to cool the hydrogen generated by the SOEC.

2-8. (canceled)

9. The system of claim 1, wherein the SOEC comprises a radioactive material configured to dissociate hydrogen from the steam using radiolysis.

10. A method for generating hydrogen using thermal energy in a geothermal fluid, comprising:
operating a valve to extract geothermal fluid from a geothermal fluid source;
operating an electrical power generation subsystem to generate electrical power using thermal energy in the geothermal fluid;
generating steam using thermal energy in the geothermal fluid and the electrical power generated by the electrical power generation subsystem;
supplying the steam to a solid oxide electrolyzer cell (SOEC); and
dissociating hydrogen from the steam using the electrical power generated by the electrical power generation subsystem;
wherein operating the electrical power generation subsystem comprises using a flash column to generate steam from the geothermal fluid to drive a turbine,
wherein generating the steam comprises operating a water purifier configured to generate purified water from untreated water, transferring thermal energy from the geothermal fluid to a portion of the purified water, and heating the portion of the purified water using the electrical power generated by the electrical power generation subsystem,
wherein dissociating hydrogen from the steam includes operating the SOEC to dissociate hydrogen from the steam using electrical power generated by the electrical power generation subsystem, and
wherein the portion of purified water comprises a first portion of the purified water and further including cooling hydrogen generated by the SOEC using a second portion of the purified water.

11-17. (canceled)

18. The method of claim 10, further including using radiolysis to dissociate the hydrogen from the steam.
